(19) United States
(12) Patent Application Publication
(10) Pub. No.: US 2004/0066045 A1
(43) Pub. Date: Apr. 8, 2004

(54) Wind powered energy generator

(76) Inventor: Alfonso Aguilar, El Paso, TX (US)

Correspondence Address: Alfonso Aguilar, 904 Bolivia St., El Paso, TX, 79903-4920, US

(21) Appl. No.: 10/263,242

(22) Filed: Oct. 3, 2002

(51) Int. Cl. F03D 9/00; H02P 9/04

(52) U.S. Cl. 290/55

(57) ABSTRACT

A portable wind powered energy generator comprises a base, a frame coupled to the base, a central axis around which a main shaft is disposed, and a plurality of support arms, each symmetrically disposed about the central axis and having a first end coupled to the main shaft.

A plurality of elongated, rotating about two axes, thin, substantially identical energy collectors, each coupled to an associated support arm, and disposed generally symmetrically about and on average rotating about a common central axis.

Each individual axis rotating about the common central axis.

The rotation of each energy collector about its individual axis is controlled by cam means which position the associated energy collector to substantially maximize the cross-sectional area which interrupts the wind while the collector is moving down-wind and minimizes the area while the collector is moving up-wind.

### BACKGROUND OF THE INVENTION

1. Field of the Invention

The present invention relates to wind powered energy generators which increase efficiency by using cams to alter and increase the cross-sectional area that the faces of the energy collectors present to the wind, which faces rotate around two axes.

2. Description of the Prior Art

Wind energy collectors or energy generating devices, also called windmills, have been used for many centuries. Earlier uses include pumping water. Recent uses include the conversion of wind energy into electricity. Windmills where the energy is collected by rotating blades have certain advantages and are the dominant form for converting wind power to more useable forms of power. Some European countries now collect about ten percent of their electricity from the wind. Wind is expected to be a major source of renewable energy required by the UN Kyoto Protocol.

An obstruction, such as the blades of a windmill, generates more energy as a function of the area the blades sweep during rotation. For this reason, and because bigger windmills catch the wind farther from the ground where the wind usually blows with greater velocity, and because the windmill can generate electricity at higher wind velocities if the windmill is stronger, recently constructed bigger windmills are more cost effective for fixed energy collecting sites. Because of their shape, especially the torque near generated by spinning blades, most prior art windmills are delicate and prone to damage in high winds.

Windmills typically are designed to rotate into the wind the axis about which their blades rotate in order to maximize the cross-sectional area of wind caught by the plane defined by the blades.

Windmills are seldom if ever used as portable energy devices because the prior art windmills are high in relation to their other dimensions, and therefore of an inconvenient shape, difficult to move and likely to be damaged if they are moved. If allegations of serious damage to be caused by global warming caused by increased carbon dioxide in the atmosphere which in turn is caused in part by the generation of energy by the burning of carbon based fuels are true, there will be a need for portable wind energy collectors. For example, a portable wind energy collector such as the present invention would be more efficient than a sailboat, since not only could wind energy be used while the boat was in motion, but a battery could be charged while the boat was at anchor. The prior art does not include or disclose such a device, which is rugged, relatively energy efficient, and so inexpensive to manufacture that it is commercially practical.

### SUMMARY OF THE INVENTION

A wind powered energy generator comprises a base supporting a frame coupled to the base, a central axis around which a main shaft is disposed, and a plurality of support arms, each symmetrically disposed about the central axis and having a first end coupled to the main shaft.

Energy is collected from the wind by a plurality of elongated, rotating about two axes, thin, substantially identical energy collectors. Each energy collector is coupled to an associated support arm. All of said energy collectors are disposed generally symmetrically about and on average rotating about the common central axis and each energy collector rotates about its individual axis about which it is generally asymmetrically disposed.

Each individual axis rotates about the common central axis. Each energy collector rotates at the same average rotational velocity about the central axis and about its individual axis.

The rotation of each energy collector about its individual axis varies as a function of rotational location and is controlled by cam means which position the associated energy collector to substantially maximize the cross sectional area the energy collector presents to the wind during that phase of rotation about the central axis when the energy collector is collecting energy from the wind, and to substantially reduce the cross sectional area presented to the wind during that phase of the rotation around the common axis when the energy collector is tending to move against the wind.

Cam control means couple each cam means to the base and to its associated energy collector so that the cam means increases the rotational velocity of the energy collector about the energy collector's axis during part of the rotational cycle and reduces said energy collector rotational velocity about its axis during part of the cycle so as to increase the total net energy collected by the energy collector by maximizing the cross-sectional area presented to the wind when the energy collector is rotating down wind and collecting energy.

Wind direction detector means such as a wind vane is coupled to the base to determine the direction from which the wind is coming and coupled to orientation means which rotate the rotating energy collectors and carn means so as to maximize the energy collected from the wind by the energy collectors. The wind direction detector means comprises a wind vane coupled to control wind vane rods which are coupled via wind vane sprockets to turn the frame so that the cam control means coupled to control each cam control the cams as a function of the rotation of the support arms around the main axis so that the energy collectors tend to present the largest possible surface toward the wind;

The invention is not elongated like wind mills, but rather can be designed to have relatively the same length along the x, y, and z axes so as to be relatively cube shaped, and therefore is easily portable.

Only one of a high speed electricity generator and a low speed electricity generator is coupled to be driven by energy from the energy collectors.

Sprockets couple power from the energy collectors to the electricity generators. Shafts coupled via the sprockets and pulleys, transmit energy from the energy collectors to the electricity generator.

### DRAWING DESCRIPTION

Reference should be made at this time to the following detailed description which should be read in conjunction with the following drawings, of which:

FIG. 1 shows the wind powered energy generator from a first direction along the length of its axes, illustrating its axes as lines; and

FIG. 2 shows the wind powered energy collector from a view orthogonal to the view of FIG. 1 illustrating its axes as points.

### DETAILED DESCRIPTION

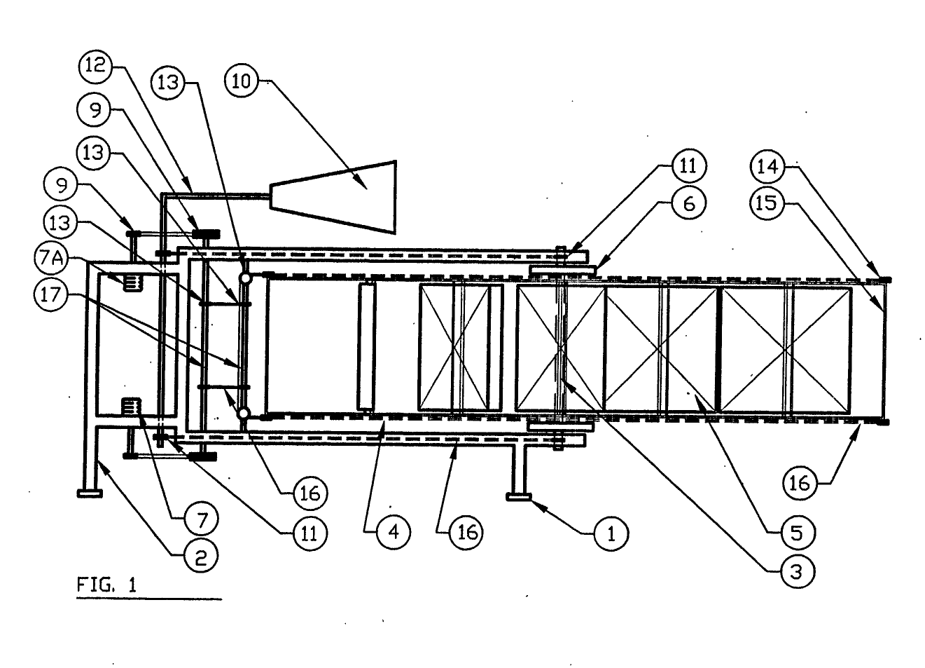

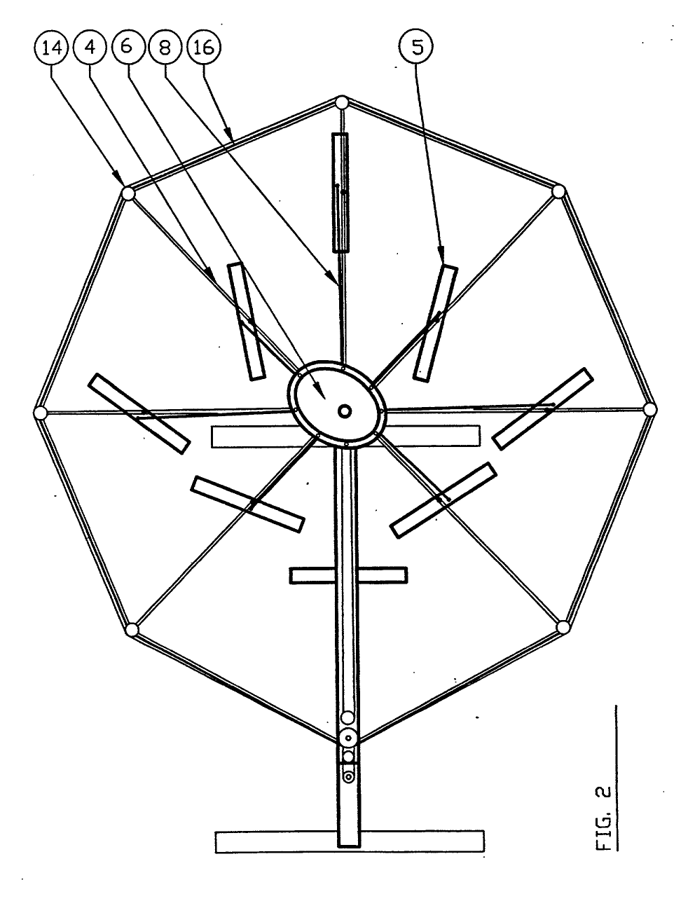

Reference should be made at this time to FIGS. 1 and 2 which illustrate a wind powered energy generator 20, comprises a base 1 supporting a frame 2 coupled to the base 1, a central axis 3′ around which a main shaft 3 is disposed, and a plurality of support arms 4, each symmetrically disposed about the central axis 3 and having a first end coupled to the main shaft 3.

Energy is collected from the wind by a plurality of elongated, rotating about two axes, thin, substantially identical energy collectors 5. Each energy collector 5 is coupled to an associated support arm 4. All of said energy collectors 5 are disposed generally symmetrically about and on average rotating about the central common central axis 3′ and each energy collector 5 rotates about its individual axis 21 about which it is generally asymmetrically disposed.

Each individual axis 21 rotates about the common central axis 3′. Each energy collector 5 rotates at the same average rotational velocity about the central axis 3′ and about its individual axis 21. The reason why the rotation is not identical is that the energy collectors 5 rotate at a varying speed as a function of their angular displacement so that they can generally keep their largest possible area facing the wind.

The rotation of each energy collector about its individual axis 21 varies a function of rotational angle to maximize energy collected from the wind and is controlled by cam means 6 which position the associated energy collector 5 to substantially maximize the cross sectional area the energy collector 5 presents to the wind during that phase of rotation about the central axis 3′ when the energy collector 5 is collecting energy from the wind, and to substantially reduce the cross sectional area presented by the energy collector 5 to the wind during that phase of the rotation around the common axis 3′ when the energy collector 5 is tending to move against the wind.

Cam control means 8 comprising cam control rods 8 couple each cam means 6 to the base 1 and to its associated energy collector 5 so that the cam means 6 increases the rotational velocity of the energy collector 5 about the energy collector's axis 21 during part of the rotational cycle and reduces said energy collector 5 rotational velocity about its axis 21 during part of the cycle so as to increase the total net energy collected by the energy collector 5 by maximizing the cross-sectional area presented to the wind when the energy collector is rotating down wind and collecting energy.

Wind direction detector means 10 such as a wind vane 10 is coupled to the base 1 to determine the direction from which the wind is coming and coupled to orientation means 22 which rotate the rotating energy collectors 5 and cam means 6 so as to maximize the energy collected from the wind by the energy collectors 5. The wind direction detector means 10 comprises a wind vane 10 coupled to control wind vane rods 12 which are coupled via wind vane sprockets 11 to turn the frame 2 so that the cam control means coupled to control each cam control the cams as a function of the rotation of the support arms around the main axis so that the energy collectors tend to present the largest possible surface toward the wind;

The invention is not elongated like wind mills, but rather can be designed to have relatively the same length along the x, y, and z axes so as to be relatively cube shaped, and therefore is more easily portable.

Only one of a high speed electricity generator and a low speed electricity generator 7 is coupled to be driven by energy from the energy collectors 5.

Generator sprockets 13 couple power from the energy collectors 5 to the electricity generators 7. Shafts 17 coupled via associated sprockets and pulleys, transmit energy from the energy collectors 5 to the electricity generator 7.

A particular example of the invention has been described herein to comply with the requirements of the Patent code. Other examples of the invention will be obvious to those skilled in the art. The invention is limited only by the following claims.

What is claimed is:

1. A wind powered energy generator, comprising:
a base, a frame coupled to the base, a central axis around which a main shaft is disposed, and a plurality of support arms, each symmetrically disposed about the central axis and having a first end coupled to the main shaft;
a plurality of elongated, rotating about tvo axes, thin, substantially identical energy collectors, each energy collector coupled to an associated support arm, and all of said energy collectors disposed generally symmetrically about and on average rotating about the common central axis, each energy collector rotating about its individual axis about which it is generally asymmetrically disposed;
each individual axis rotating about the common central axis;
each energy collector rotating at the same average rotational velocity about the central axis and about its individual axis.
The rotation of each energy collector about its individual axis controlled by cam means which position the associated energy collector to substantially maximize the cross sectional area the energy collector presents to the wind during that phase of rotation about the central axis when the energy collector is collecting energy from the wind, and to substantially reduce the cross sectional area presented to the wind during that phase of the rotation around the common axis when the energy collector is tending to move against the wind;
cam control means coupling each cam means to the base and to its associated energy collector so that the cam means increases the rotational velocity of the energy collector about the energy collector's axis during part of the rotational cycle and reduces said energy collector rotational velocity about its axis during part of the cycle so as to increase the total net energy collected by the energy collector by maximizing the cross-sectional area presented to the wind when the energy collector is rotating down wind and collecting energy; and
wind direction detector means such as a wind vane coupled to the base to determine the direction from which the wind is coming and coupled to orientation means which rotate the rotating energy collectors and cam means so as to maximize the energy collected from the wind by the energy collectors.

2. The invention of claim 1 wherein:
wind direction detector means comprises a wind vane coupled to control wind 11 vane rods which are coupled via wind vane sprockets to turn the frame so that the cam control means coupled to control each cam control the cams as a function of the rotation of the support arms around the main axis so that the energy collectors tend to present the largest possible surface toward the wind;
the invention has relatively the same length along the x, y, and z axes so as to be relatively cube shaped, and therefore easily portable;
only one of a high speed electricity generator and a low speed electricity generator is coupled to be driven by energy from the energy collectors;
sprockets couple power from the energy collectors to the electricity generators;
and shafts coupled via the sprockets and pulleys, transmit energy from the energy collectors to the electricity generator; and
the energy collectors rotational velocity varies as a function of location so as to maximize the energy collected from the wind.
